(19) United States
(12) Patent Application Publication
(10) Pub. No.: US 2017/0046530 A1
(43) Pub. Date: Feb. 16, 2017

(54) Distributed Cloud Storage System (DCSS) for secure, reliable storage and retrieval of data and computing objects

(71) Applicant: Seshan Raj, Sunnyvale, CA (US)

(72) Inventor: Seshan Raj, Sunnyvale, CA (US)

(21) Appl. No.: 14/827,294

(22) Filed: Aug. 15, 2015

(51) Int. Cl. G06F 21/62; H04L 29/06; H04L 29/08

(52) U.S. Cl. CPC G06F 21/6218; H04L 67/1002; H04L 63/1425; H04L 63/123; H04L 63/20

(57) ABSTRACT

Method and System for a Distributed Cloud Storage System that significantly enhances data security and application security of data and computing objects using distributed cloud servers. Data and computing objects are securely stored by shredding, encryption and storage distributed across multiple cloud servers. Data and computing objects are retrieved after de-shredding, decryption and reconstruction verification done at server level, shred level or at a bits/bytes level. Server certificates are verified, abnormality usage inspected and alerts generated. The system continually learns and improves performance and security via server scaling, load balancing, abnormality detection from usage pattern monitoring, reliability improvement via storage duplication and adaptive modifications to security algorithms.

### BACKGROUND

### Cross-References to Related Applications

Relevant links and patents
1. http://en.wikipedia.org/wiki/Cloud computing
2. http://en.wikipedia.org/wiki/Data masking
3. http://en.wikipedia.org/wiki/Cloud computing security
4. http://en.wikipedia.org/wiki/MaidSafe
5. http://www.reuters.com/article/2014/01/12/us-target-databreach-retailers-idUSBREA0B01720140112
6. http://krebsonsecurity.com/2014/01/a-first-look-at-the-target-intrusion-malware/
7. http://en.wikipedia.org/wiki/Brute-force_attack
8. http://datasys.cs.iitedu/reports/2012_GCASR12_paper IDA.pdf
9. http://searchstorage.techtarget.com/definition/erasure-coding
10. http://www.computerweekly.com/feature/Erasure-coding-versus-RAID-as-a-data-protection-method
11. http://www.google.com/patents/U.S. Pat. No. 7,904,475
12. https://www.google.com/patents/U.S. Pat. No. 7,546,427?dq=cleversafe&hI=en&sa=X&sqi=2&pjf=1&ved=0CDIQ6AEwA2oVChMIoMHd3bGixwIVwy6ICh0PwgBc
13. Patent: Data storage in cloud computing—US 20140019755
14. How to Share a Secret, by A. Shamir, Communications of the ACM, Vol. 22, No. 11, November, 1979
15. Patent: Systems and methods for securing data in the cloud—EP2433409A2
16. System for rebuilding dispersed data U.S. Pat. No. 7,546,427 B2
Keywords for search—cloud, data security, application security, remote access, cloud computing, VPN, database security, abnormal, pattern detection, data theft, data leakage, erasure coding, RAID, information dispersal algorithm

### Field of Invention

The invention is about improving data and application security over current and prior art using distributed cloud servers. Invention provides:
(a) Improved data security for data—by shredding, encrypting and storing in multiple cloud servers making it harder for hackers to steal or corrupt data.
(b) Improved application security for computing programs—by shredding and storing programs in multiple places making it harder for hackers to hack and steal or corrupt computing programs or add malware.
(c) Improved authentication of data and programs via secret re-ordering algorithms that track the order in which a data or computing object is reconstructed making it harder for hackers to attack and steal or corrupt data and computing programs.
(d) Learning system to improve performance and security—by server scaling, load balancing, abnormality detection and adaptive modifications to security algorithms.
(e) Improved user and application identity management—by shredding, encrypting, storing and authenticating of identity related data and computing objects by multiple cloud servers making it harder for hackers to steal critical identification such as passwords, security tokens, authentication images etc.

### Discussion of Prior Art

Currently data and application security is achieved by enterprises using
1. Network, server and application firewalls—these may be set up around machines and/or virtualized instances containing user applications and data files protecting network ports and monitoring restricting network access.
2. Data Encryption—data files may be encrypted for storage and decrypted by valid users.
3. Data Obfuscation—data hidden by masking file names, adding random characters etc.
4. Data Splitting—splitting and encrypting files across multiple servers and locations. http://searchsecurity.techtarget.com/definition/data-splitting
5. Data masking or data hashing or tokenization
6. Application security monitored via vulnerability testing.
7. Application input controls prevent SQL Injection type attacks.
8. Application controls prevent brute force attacks to guess passwords, prevent denial of service attacks.
9. Stored and managed by single computing servers. Attackers can hijack the server and use brute force techniques to steal data.
10. Anti-virus/malware checking and using well certified and firewall protected servers.
11. Identity management and abnormality rule checking.
   What is NEW in this Invention?
1. The DCSS Server targets to improve security of data and computing objects by shredding, encrypting, storing, retrieving and authenticating them from a distributed cloud of servers and databases. These cloud servers may be public or private. Data and computing objects may be located privately within a firewall or held publicly outside the firewall.
2. DCSS server can enhance data security and application security. This is critical for achieving security in distributed and cloud computing where both data and computer programs are stored in cloud servers. Typically applications running on servers use both data and computer programs which need to be protected. Example in a point of sale system used by a clerk to enter customer and product purchase information and then process the customer's credit card for payment the data and computing objects include: data about customer, data about product, purchase data, program to authenticate the clerk processing the sale, program to process customer's credit card, program to alert shipping system on sale of product and to commence shipment.
3. Hacker attacks to steal data and/or corrupt programs is more difficult since an attacker must be able to access all the distributed cloud servers utilized in storing the data and computing objects. Today typically data and computing programs are stored in a single server.
4. We can scale up performance, reliability and security by utilizing unlimited cloud servers.
5. Insider threat is minimized since the distributed cloud of servers might include multiple vendors and independent data centers.
6. An attacker must know the de-shredding and decryption algorithms and the keys employed at each server where we store the shredded, encrypted data and computing objects.
7. If the system detects an attack it could adaptively change the type and complexity of the security algorithms such as the encryption/decryption algorithms, the shredding/de-shredding, the order of assembly etc.
8. An attacker must know the order of re-assembling data and computing objects.
9. Invention offers a ‘just in time’ security model where data and computing objects are normally stored shredded, encrypted and distributed then brought together just when required. Thus making it very difficult for attackers who have to attack a large number of servers and locations and know the scheme of re-assembly. DCSS can be deployed within the firewall or outside the firewall of a user or enterprise.

DCSS handles data and computing objects. In addition DCSS adds additional security via abnormality detection performed at every instance of DCSS. Server verification is performed by specifying at store time the re-assembly order to re-assemble shredded data assembly. Verification is done at read time to match actual re-assembly order to expected re-assembly order.

### OBJECTS AND ADVANTAGES

1. DCSS Server—enables secure and reliable storage and retrieval of data and computing objects (DCO) using distributed cloud servers and databases.
2. Shredding system—shreds data and computing objects (DCO) before or after encryption.
3. Encryption system—encrypts data and computing objects before or after shredding.
4. Distribution system—distributes and stores shredded and encrypted data and computing programs across a distributed cloud of servers and databases.
5. Adaptive security algorithms—each server in the cloud may follow multiple different shredding, encryption and distribution algorithms.
6. Key management system—manages keys for retrieving data and computing objects stored after shredding, encryption and distribution.
7. De-shredding system—de-shred DCO.
8. Decryption system—decrypt DCO
9. Re-assembly verification system—verify reconstruction order.
10. Server certificate validation system—check server certificates
11. Abnormality detection system detects and generates abnormality alerts. Pattern detection, threat identification is done using statistical modeling. Policy rules may be implemented—for example limits on data usage levels or limits by content type or limits based on users. Alerting systems to alert administrators and managers via emails or text alerts
12. Learning system for performance tuning—via server scaling, load balancing of cloud servers and databases.
13. Learning system for reliability enhancement—reliability monitoring, data duplication management and scaling of servers for improving reliability
14. Learning system for security enhancement—adaptive modifications to security algorithms based on security threat monitoring.
15. Learning system for abnormality detection—for usage pattern profiling and generating alerts.
16. Auditing and Logging System—Module for logging user usage. Data thefts can be traced backward to specific users who may have downloaded large amounts of data or critical data.

### Example Commercial Opportunity:

Retail is huge with transactions running into trillions of dollars. Retail businesses are currently facing huge security threats and daily attacks. Current generation of POS systems have been attacked with sophisticated malware which infects and steals sensitive customer and credit data costing retailers billions of dollars (example Target Stores).

DCSS would significantly improve both data and application security for retail computing by allowing more secure and reliable storage and retrieval of data and computing programs, scripts etc.

### BRIEF DESCRIPTION OF DRAWINGS OF THE PREFERRED EMBODIMENT

FIG. 1: Title

Distributed Cloud Storage System (DCSS) for secure, reliable storage and retrieval of data and computing objects

FIG. 2: Illustrates Data and Computing Objects

FIG. 3: Illustrates DCSS Functions

FIG. 4: DCSS Deployment Example

DCSS may be deployed behind enterprise firewalls as well deployed within each server in the distributed cloud.

FIG. 5: Public or Private Cloud

FIG. 6: DCSS Components

FIG. 7: Shredding System—Shred DCO

FIG. 8: Encryption System—Encrypt DCO

FIG. 9: Distribution System—Distribute DCO

FIG. 10: Key Management System—Generate SED (Shred, Encrypt, Distribute) Keys

FIG. 11: Key Management System—Access SED (Shred, Encrypt, Distribute) Keys

FIG. 12: Decryption System—Decrypt DCO

FIG. 13: De-shredding System—De-Shred DCO

FIG. 14: Re-assembly Verification System—Verify reconstruction order

FIG. 15: Server Certificate Validation System—check and verify server certificates

FIG. 16: Abnormality Detection System—detect and generate abnormality alerts

FIG. 17: Key Management System—Verify SED Keys

FIG. 18: DCSS Learning System

FIG. 19: Compare DCSS to prior art

FIG. 20: Use Case (1)

Protect data storage with DCSS

FIG. 21: Use Case (2)

Protect Computer Application with DCSS

FIG. 22: Use Case (3)

Protect against web page phishing attacks with DCSS

FIG. 23: Use Case (4)

Enhance passwords and security tokens

### DETAILED DESCRIPTION

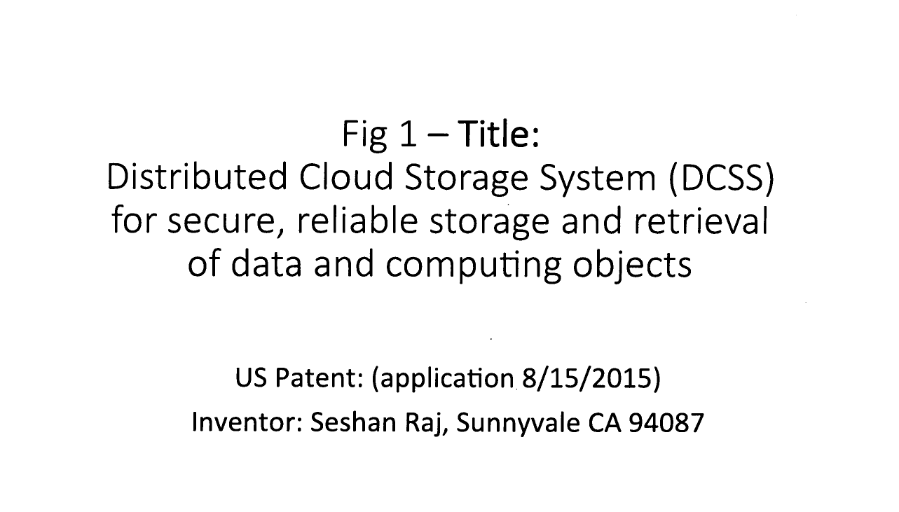

FIG. 1. Title page.

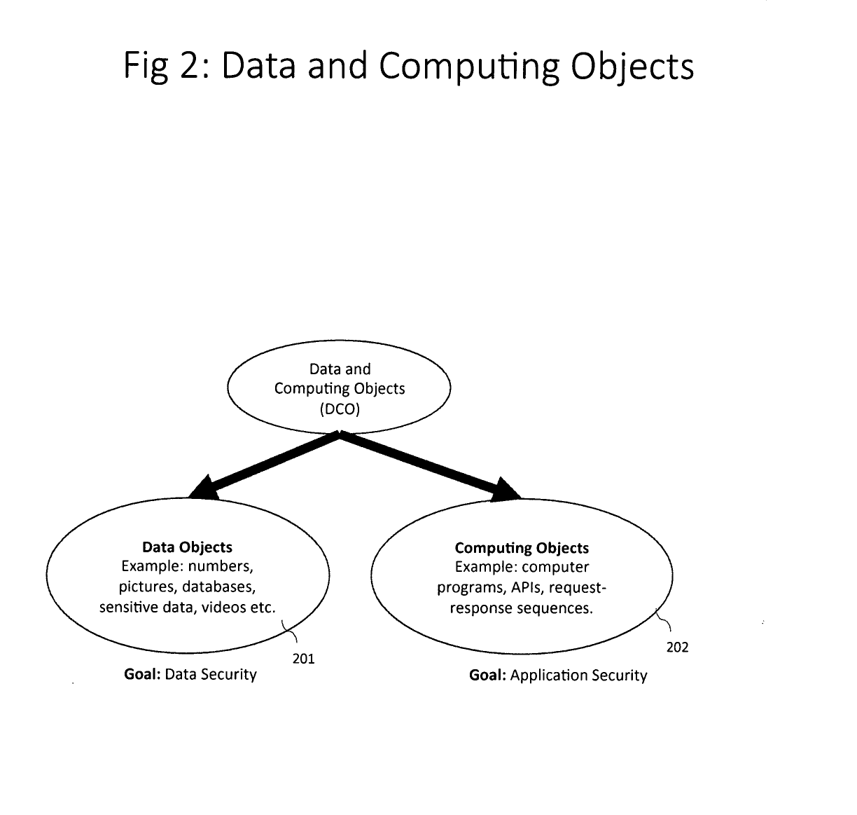

FIG. 2. Illustrates that Data and Computing Objects (DCO) is defined as Data Objects (201) example text, numbers etc. and Computing Objects (202) such as computer programs, computer scripts, server APIs etc.

DCSS stores data and computing objects after shredding and encrypting data across cloud servers. Retrieve data and computing objects from cloud server locations after decrypting and de-shredding

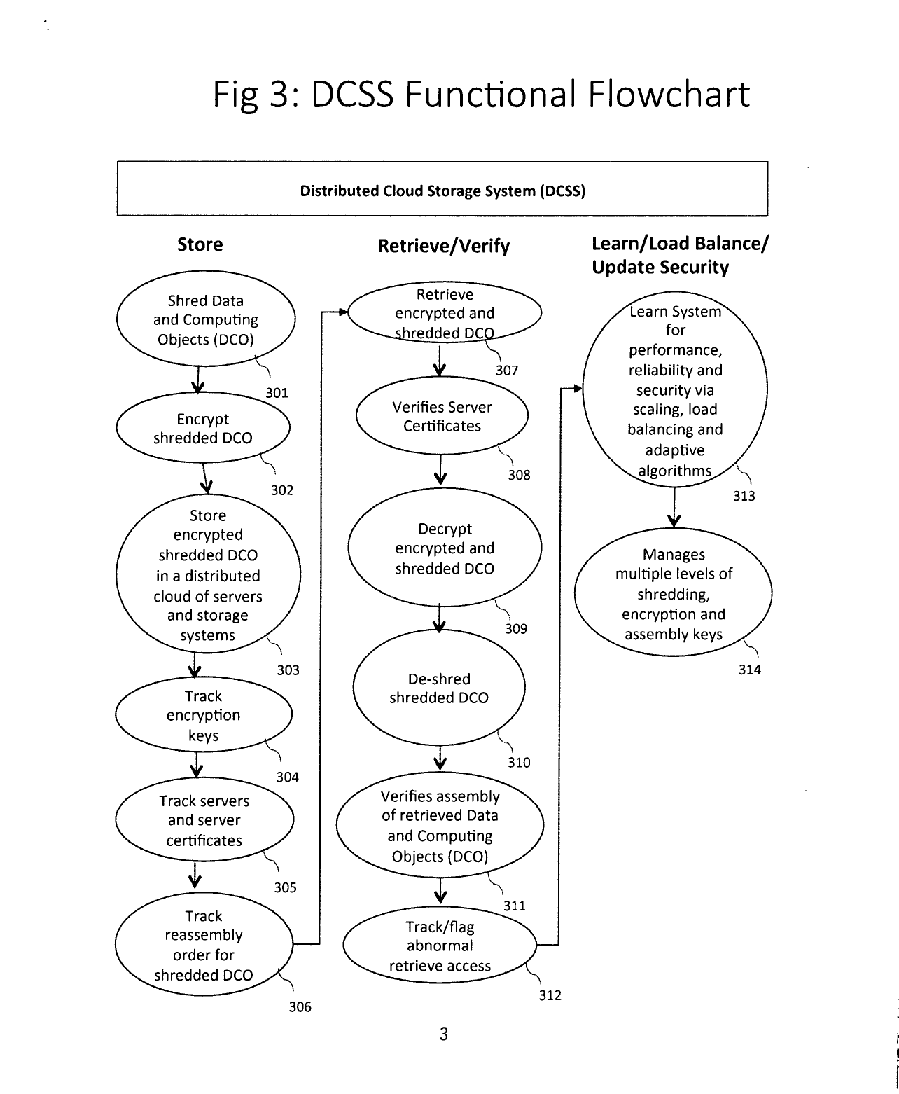

FIG. 3. Illustrates DCSS functional flowchart. The main functions performed by DCSS are Store DCO, Retrieve DCO, Verify DCO retrieval authenticity and Learn/Load Balance Servers/Update Security. Steps 301 through 314 are performed for these functions. It must be noted that these steps need not be always in sequence shown and can be randomly performed providing inputs required by the step are available. For example the Learn System (313) may occur in parallel to any of the steps tracking reliability, performance and security. The retrieve sequence of steps 307 through 312 may be running in parallel to the store sequence of steps 301 through 306. Verification step (311) may occur in parallel to the de-shredding process (310).

Also shredding (301) may be performed before or after encryption (302) based on a setup choice. Similarly decryption (309) may occur before or after de-shredding (310) based on setup choice.

DCSS application programming interface (API) commands would include
1) STORE data and computing programs into DCSS—provide Input data file and computing objects (programs, scripts etc.) to DCSS which then automatically shreds, encrypts and stores distributed in a cloud of servers. Mandated order re-assembly is also stored. Returns a master key which may be independently stored by the user or application. DCSS distributes shredded and encrypted DCO to multiple cloud based servers and databases. DCSS security algorithm management system is referenced to determine what algorithm to use for shredding, encryption, distribution and re-assembly order. DCSS key management system manages and stores keys used by the security algorithms.
2) RETRIEVE data and computing objects (programs, scripts etc.) from DCSS after providing master key. DCSS automatically retrieves data and computing objects across distributed cloud servers, then de-shredding and decrypting. Oder of re-assembly is also verified against the mandated order of re-assembly.
3) VERIFY data and computing objects (programs, scripts etc.) by verifying server certificates and verify the order of re-assembly of data and computing objects—at the shred level as well at the bit and byte level. Verify also check for valid passwords and security tokens required in authenticating users and applications.

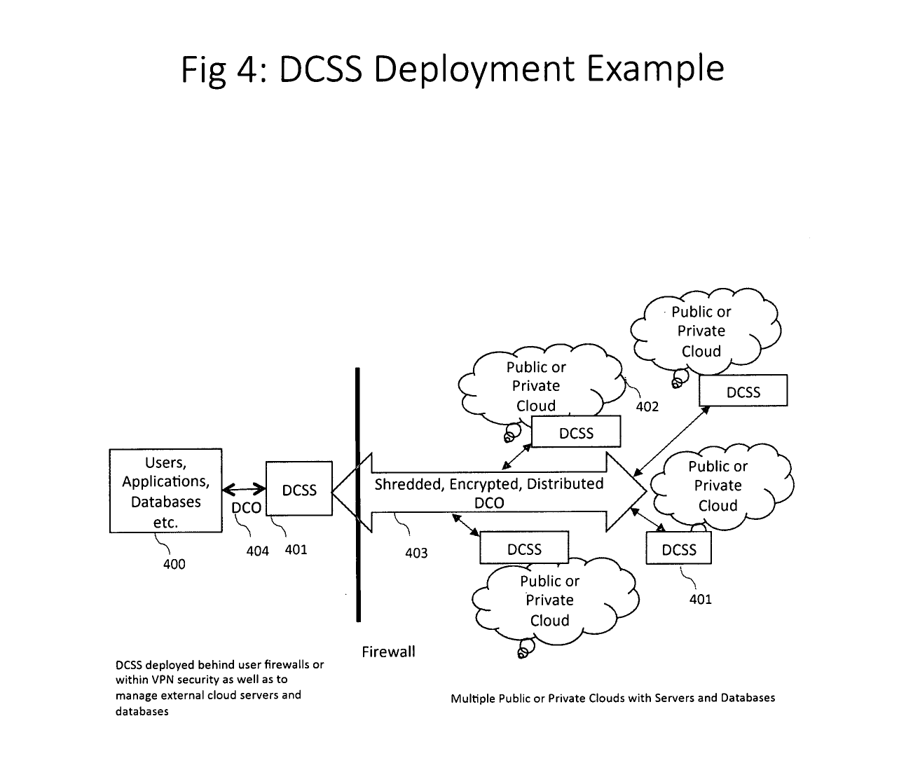

FIG. 4. Shows a deployment example with data and computing objects (DCO) generated by users, applications, databases etc. The DCO is processed by DCSS (401) via shredding, encrypting and then distributing to a public or private cloud (402) managed by DCSS systems located at each cloud storage location.

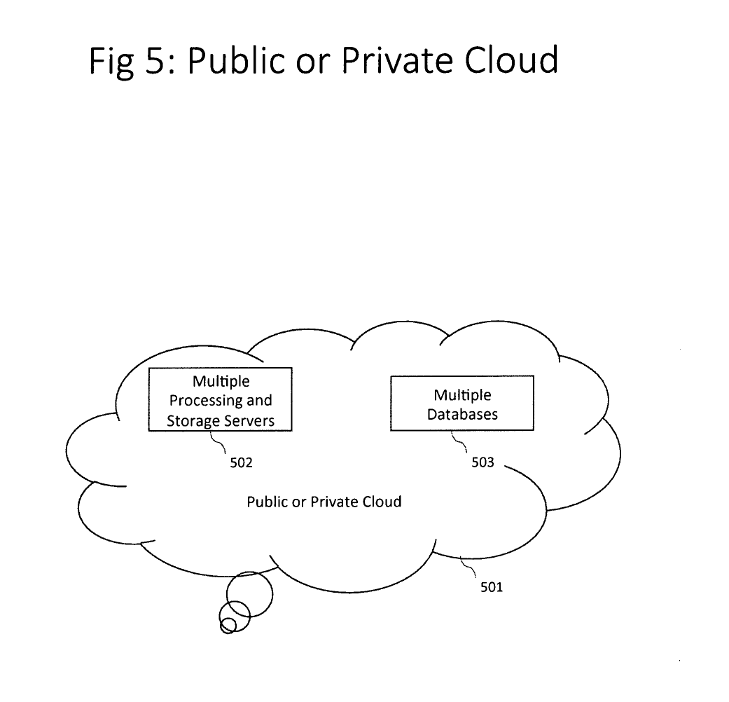

FIG. 5. Shows public or private cloud (501) may be comprised of processing and storage servers (502) as well as databases (503). This covers data that might be flowing or streaming as well as data at rest.

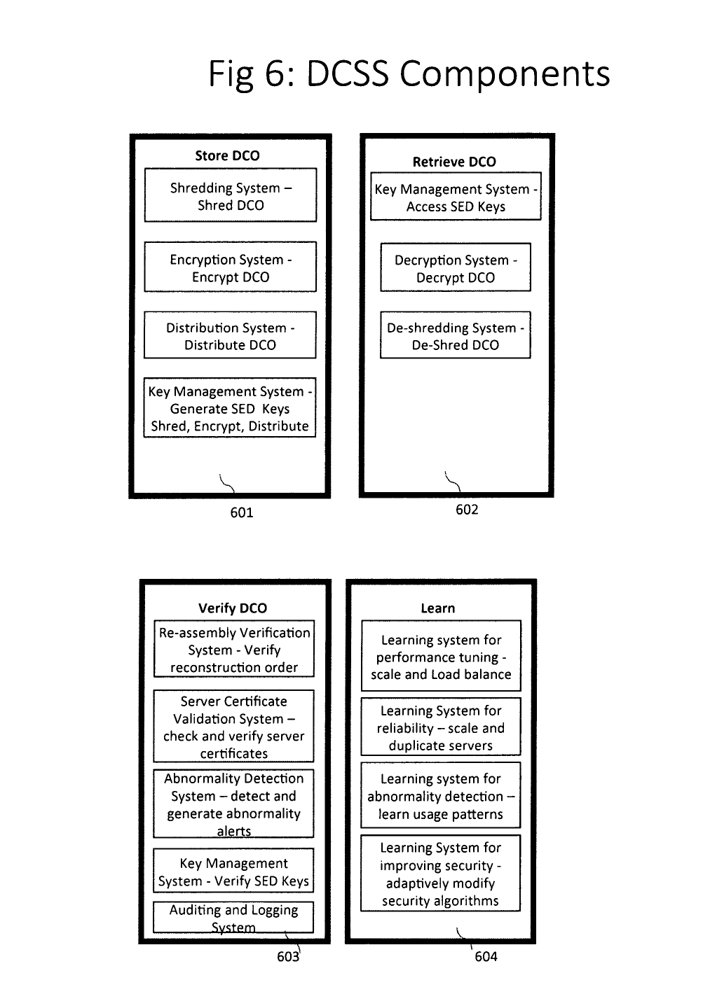

FIG. 6. Show the major components for this embodiment of the invention. DCSS components are comprised of four major modules, to Store DCO (601), to Retrieve DCO (602), to Verify DCO (603) and to Learn (604) required for improving performance, reliability and security.

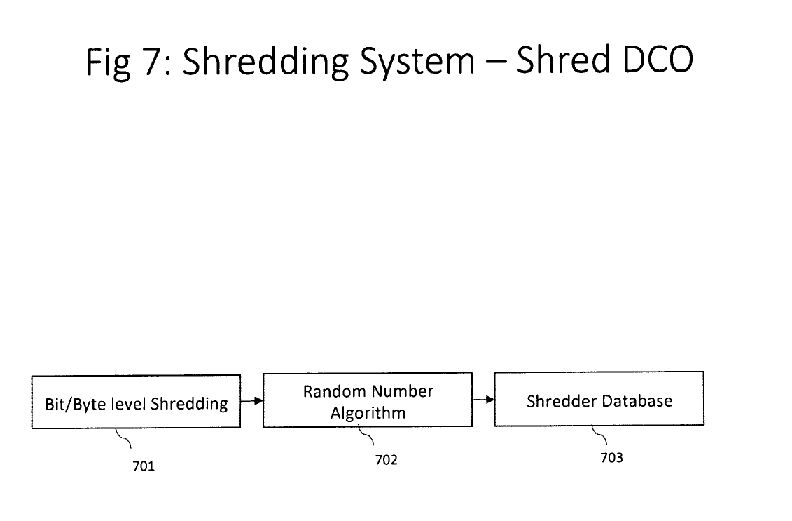

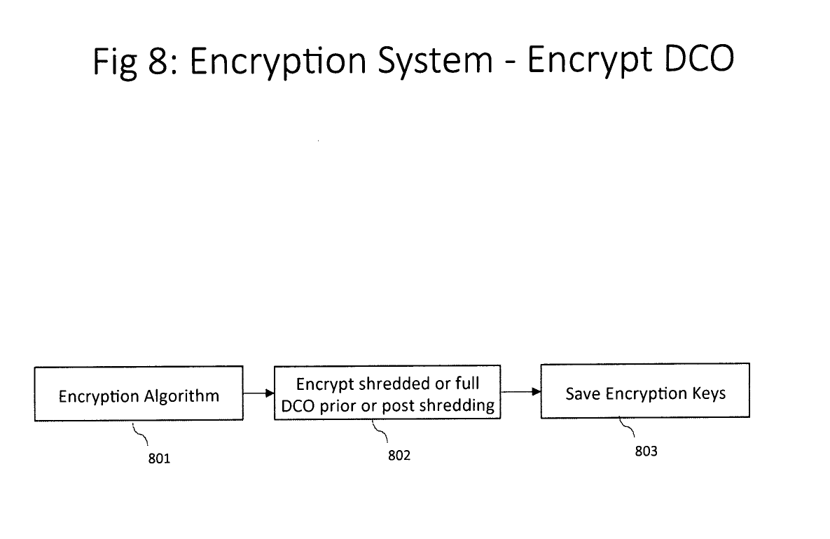

FIG. 7. Shows the DCO shredding system comprised of bit or byte level shredding (701), randomizing algorithms (702) and a shredder database (703) to store shredded data as well as store metadata on shredded data required for de-shredding. This metadata on shredding could include the re-assembly order required for verifying data de-shredding. For example this might specify that a shredded image should be built back (de-shredded) starting with pixels in the bottom third and then pixels in the bottom, then pixels in the top third. In one embodiment of the invention shredding (FIG. 7) occurs prior to encryption (FIG. 8). In another embodiment encryption (FIG. 8) may occur prior to shredding (FIG. 7).

FIG. 8. Shows the DCO encryption system comprising the encryption algorithm (801), the database storage (802) for encrypted and shredded DCO prior to storing on the cloud and the encryptions keys storage (803).

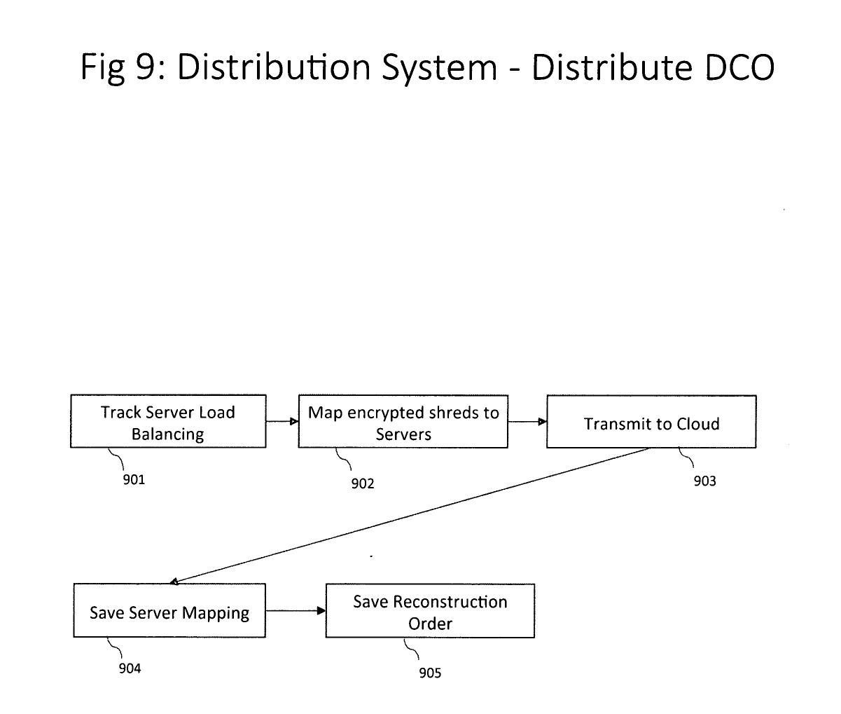

FIG. 9. Shows the DCO distribution system comprised of tracking cloud servers (901), mapping encrypted and shredded DCO (902) to cloud servers, transmitting to cloud (903), saving cloud server mapping (904) and saving the data on the reconstruction order (905) which may be used to validate the authenticity of the servers. For example we could save the order of reconstructing an image at a pixel level (or shred level or byte or bit level) and this could be then checked at the time of reconstruction to ensure it is from a valid set of servers. For example if the picture is to be reconstructed mid section first, bottom section second and top section last then DCSS will ensure this ordering occurs at reconstruction time to validate servers.

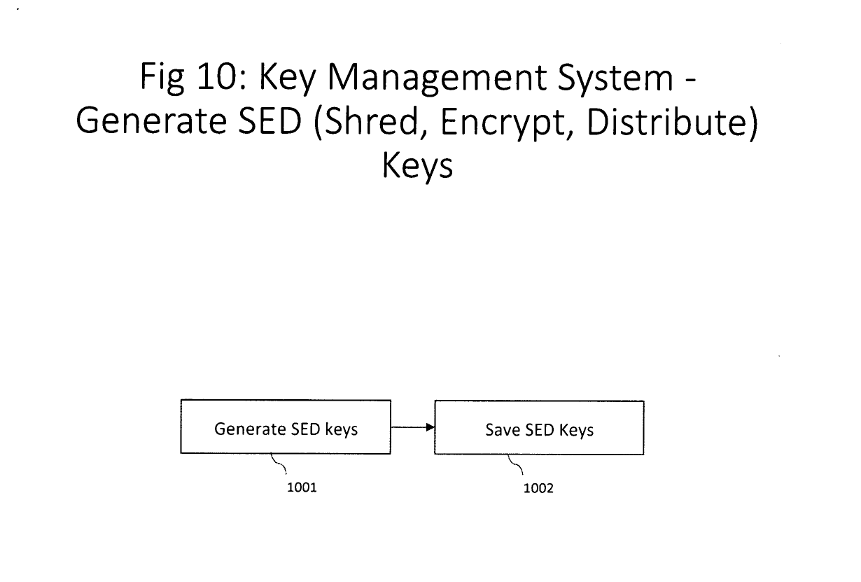

FIG. 10. Key management generation is shown here showing the generation of shred, encrypt and distribute (SED) keys (1001) and saving these SED keys to a storage device (1002). DCSS supports ‘key value database’ for tracking shredded and encrypted data and computing objects.

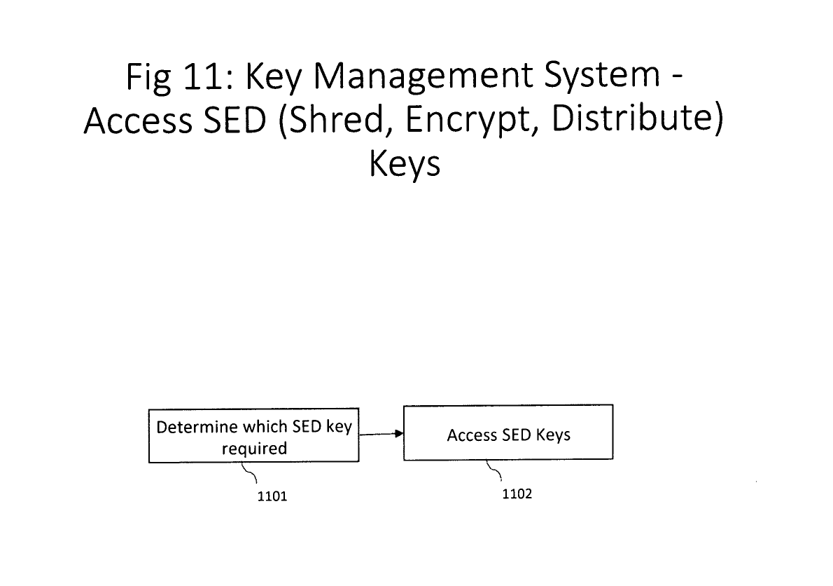

FIG. 11. Shows the key management process for accessing SED keys. First determine which SED key is required (1101) and next access the storage location where stored (1102).

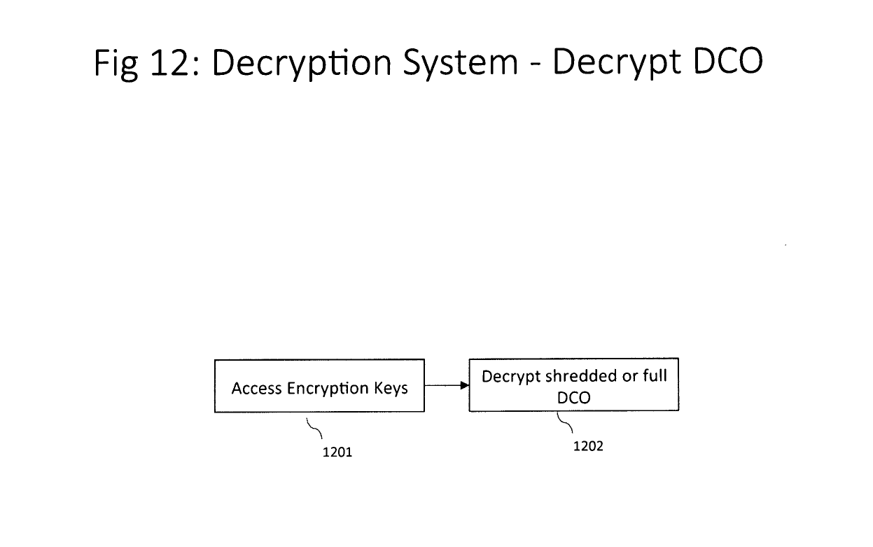

FIG. 12. Shows the decryption system to decrypt DCO. First access encryption keys (1201) which has been described in FIG. 11 above and then decrypt encrypted DCO shreds or full DCO (1202).

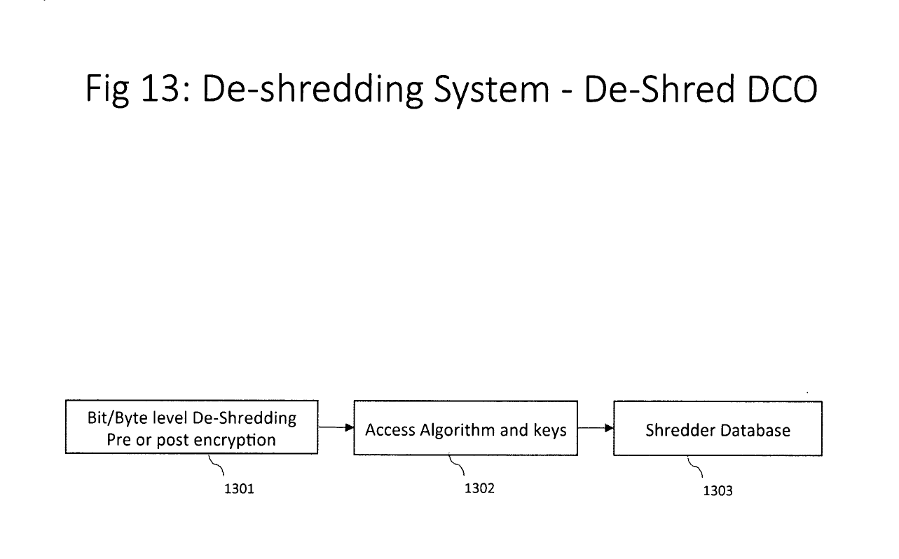

FIG. 13. De-shredding system is shown here. Bit/Byte level de-shredding (1301) may occur pre or post encryption depending on the setup.

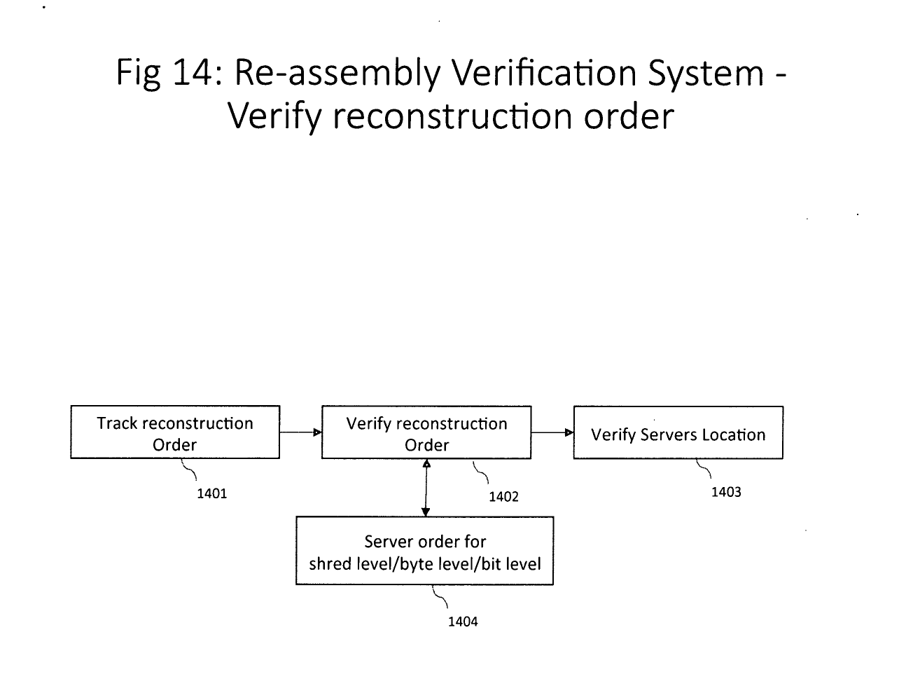

FIG. 14. Illustrates the re-assembly verification system. First we track the reconstruction order (1401) set at the time of shredding (FIG. 7). Next verify the reconstruction order (1402) and verify servers (1403) via server certificates, IP address etc. Reconstruction order might be at the shred level or the byte or bit level.

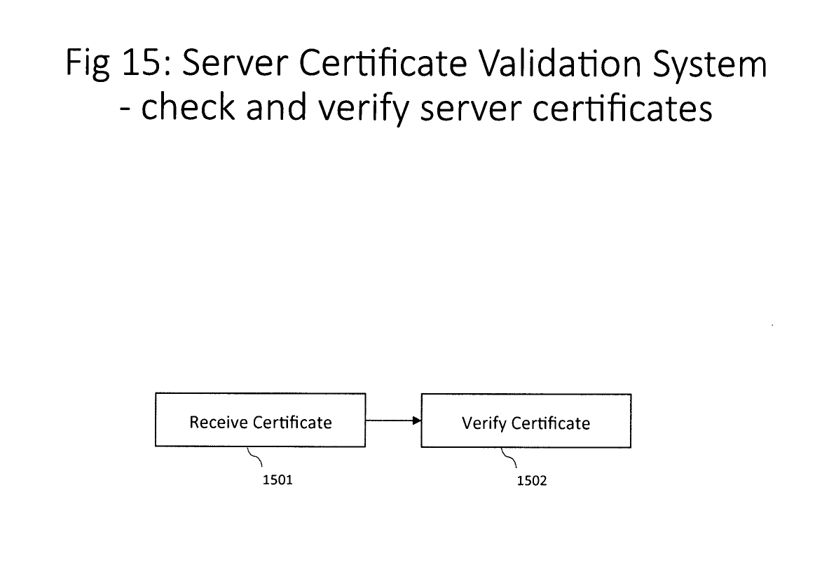

FIG. 15. Shows the process of validating server certificates—receiving certificates (1501) and verifying certificates (1502) from a valid list registered with DCSS by an administrator.

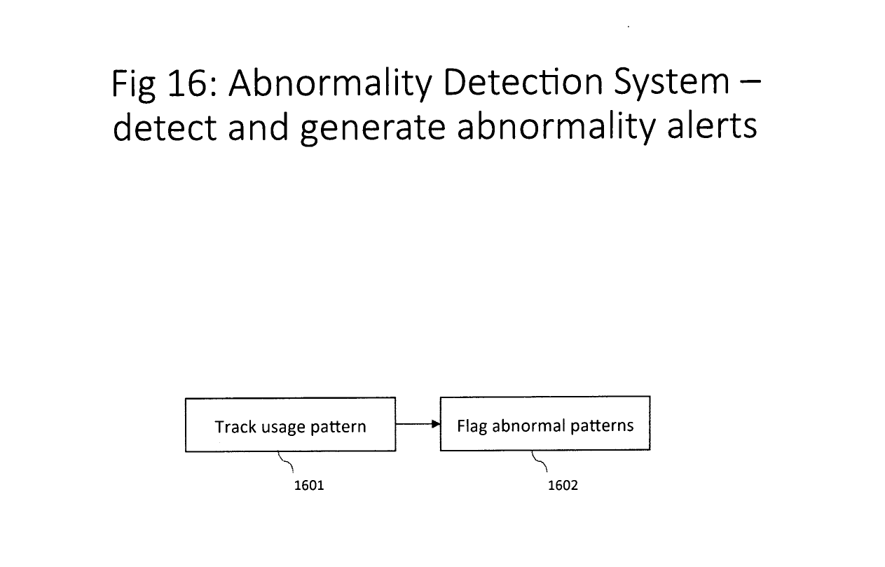

FIG. 16. Abnormality detection involves tracking usage patterns (1601) for example tracking the read cycles by different users and flagging abnormal patterns (1602) by comparing for example the number of read cycles with an abnormality flagging rule which says generate an alert if the read cycles observed exceeds a preset level.

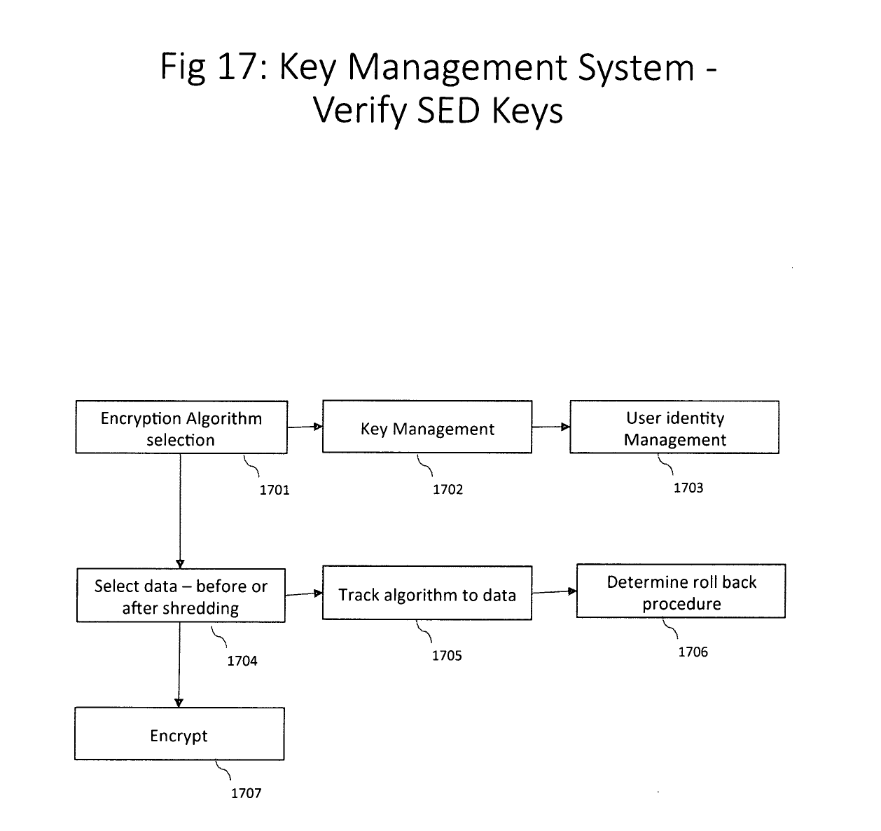

FIG. 17. Shows the verification of SED keys used in the key management system (1702) with the user identity management (1703). Keys are required for the encryption processes (1701, 1704,1707). DCSS also tracks the encryption algorithm used by various data and computing objects (1705). Thus if an encryption system is compromised DCSS can perform a rollback (1706) and substitute a different encryption algorithm.

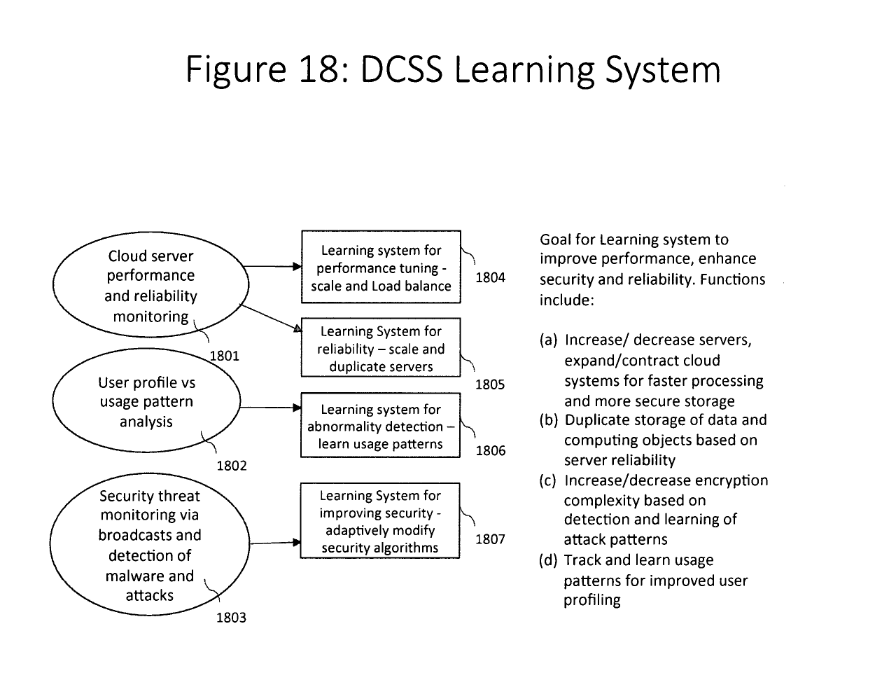

FIG. 18. DCSS learning system is shown. Goal for Learning system to improve performance, enhance security and reliability. Functions include:
a) Increase/decrease servers, expand/contract cloud systems for faster processing and more secure storage. Load balancing, scaling, duplication for performance, security and reliability
(a) Duplicate storage of data and computing objects based on server reliability
(b) Increase/decrease encryption complexity based on detection and learning of attack patterns Track and learn usage patterns for improved user profiling. Insider activity monitoring, usage pattern monitor
(c) Adaptive algorithms, switch or rollback based on threat level. Rollback and change keys if threat is identified by DCSS across servers

DCSS learning system is driven by (a) performance and reliability monitoring (1801), (b) usage analysis (1802) and (c) monitoring threat levels and malware detection (1803). Learning system drives performance tuning (1804), reliability scaling (1805), abnormality detection (1806) and adaptive modification of encryption and shredding security algorithms (1807).

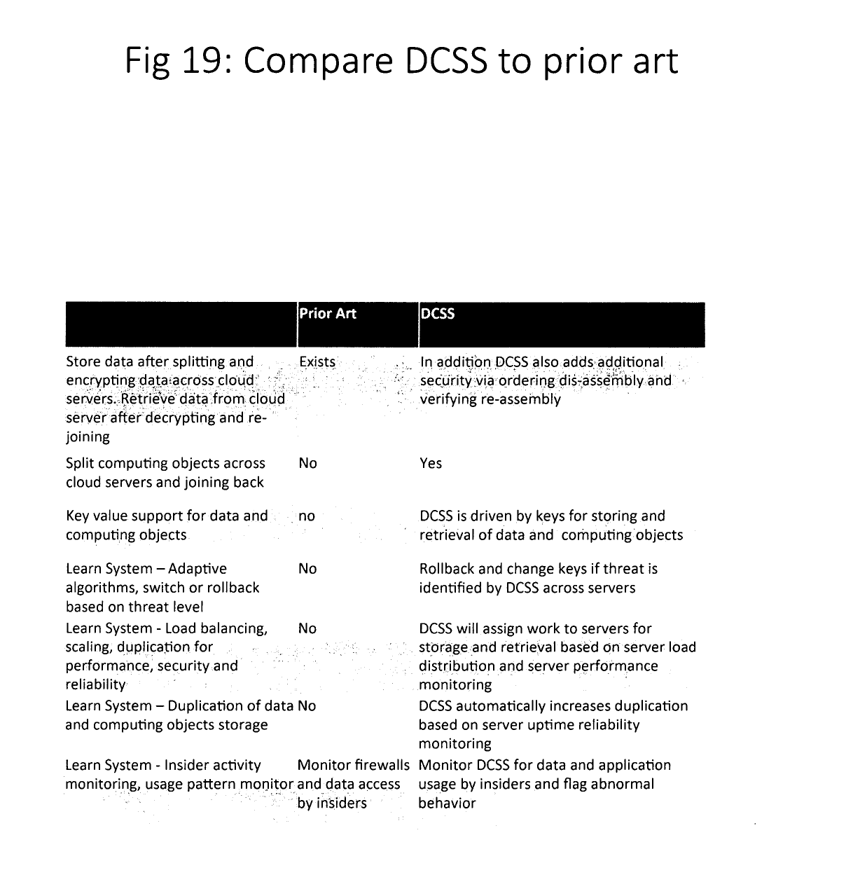

FIG. 19. Compares DCSS functions with prior art.

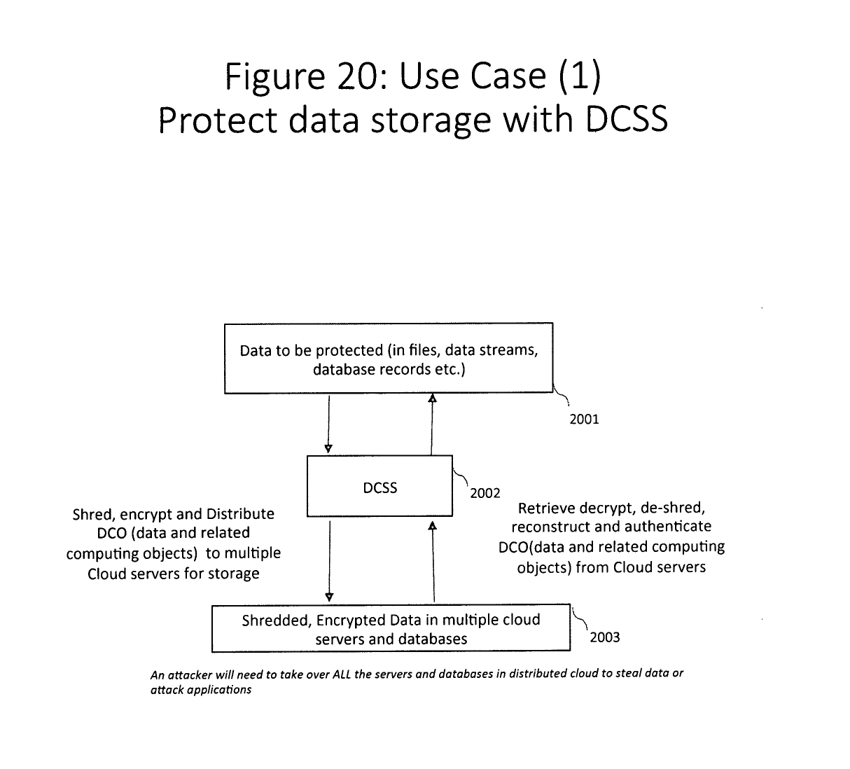

FIG. 20. Illustrates DCSS (2002) protecting data storage (2001) via shredding and encrypting to cloud server locations (2003) and retrieving data by reversing the process. This can serve to access data in a ‘just in time’ manner so that data when at rest may be stored securely in cloud locations shredded and encrypted. Example credit card numbers could be stored shredded and encrypted and then brought together just when required thus minimizing thefts by insiders and external data theft attacks.

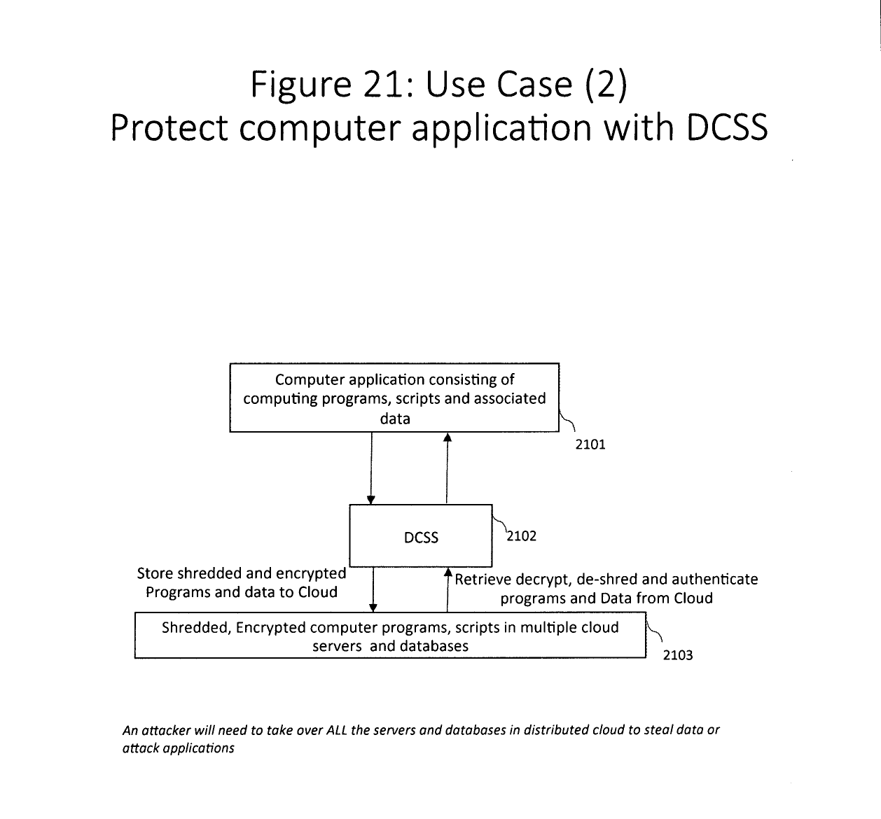

FIG. 21. Illustrates DCSS (2102) protecting computer programs, scripts etc. (2101) by storing them shredded and encrypted in cloud locations (2103) and then retrieving them in a ‘just in time’ manner. The benefit is that computer programs and scripts are brought together ‘just in time’ when required minimizing malware and worm attacks or stealing of code and corruption of code by hackers.

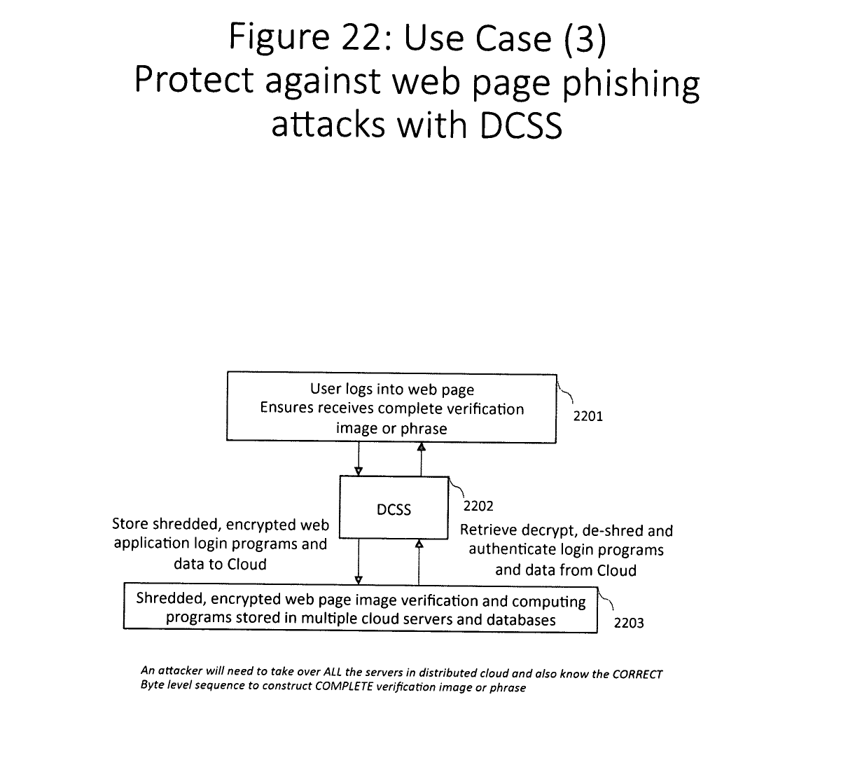

FIG. 22. Illustrates how DCSS can protect against web page phishing attacks that are used to substitute valid cloud servers with imposters that can steal user information. Users can set verification images and phrases (2201), store them shredded and encrypted in valid cloud servers (2203) and these can be checked at run time by DCSS (2202) via decryption and de-shredding and re-assembly order verification to validate the cloud servers.

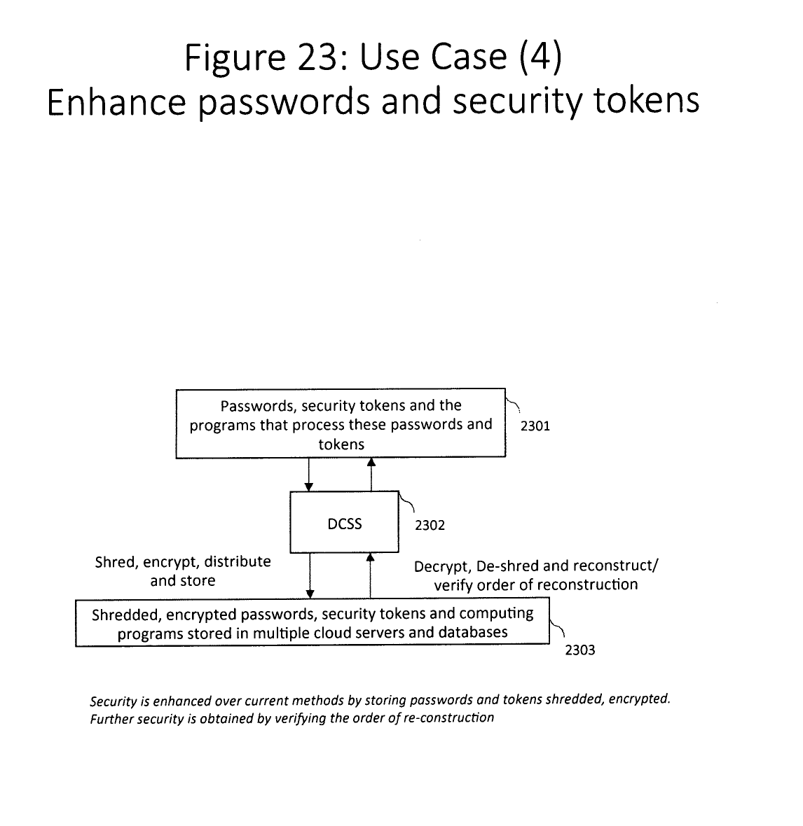

FIG. 23. Illustrates use case in user and application identity management to enhance passwords and security tokens used to get access. This security application comprising of passwords (data) and scripts to authenticate the user/application (computing objects) is enhanced in its security. Passwords and security tokens (2301) are shredded, encrypted and distributed by DCSS (2302) to cloud server locations (2303). These cloud server locations may further contain DCSS instances as in (FIG. 4) and these DCSS instances may communicate the shredded, encrypted passwords and security tokens to processing and storage servers (FIG. 5) which may independently authenticate users and applications. Note DCSS on the cloud (FIG. 4) communicates decrypted data and computing objects between single or multiple distributed cloud servers. The advantage when authenticating passwords is that we may independently authenticate each shredded character of a password and store and authenticate them separately. Users and applications are fully authenticated when all cloud-processing authentication servers return a positive authentication.

The benefits this offers is to eliminate insider threat on the cloud and offer ‘just in time’ security authentication using just a shredded portion of a password or security token

### CONCLUSION, RAMIFICATIONS AND SCOPE OF INVENTION

A system and method for data security, application security, user identification security, reliability and performance of storing and retrieving data and computing objects using distributed cloud servers and databases.

The examples and specifications given above are for providing illustrations and should not be construed as limiting the scope of the invention.

1. A method for cloud storage and retrieval of data and computing objects, said data and computing objects comprising data or computing objects or both, said cloud comprising of public cloud or private cloud or both; said cloud servers comprising storage servers or processing servers or databases or any combination thereof,
said method comprising:
shredding data and computing objects before or after encryption;
encrypting data and computing objects before or after shredding;
distributing data and computing objects to cloud servers after shredding and encryption;
tracking distributed data and computing objects, cloud servers and algorithms used in method;
retrieving shredded, encrypted, distributed data and computing objects;
decrypting data and computing objects before or after shredding;
de-shredding data and computing objects before or after decryption;
re-assembling de-shredded data and computing objects.

2. The method tracking distributed data and computing objects, cloud servers and algorithms used in method described in claim 1 further comprising:
verifying cloud servers;
tracking shredding, encryption and distribution algorithms;
tracking shredding, encryption and distribution algorithm keys;
tracking cloud server reliability;
tracking cloud server performance;
tracking abnormal access of data and computing objects;
alerting abnormal access of data and computing objects;

3. The method as described in claim 2 further comprising:
improving cloud server reliability via scaling or duplication or both;
improving cloud server performance via scaling or load balancing or both;
updating security by modifying shredding, encryption and distribution algorithms;

4. The method distributing data and computing objects to cloud servers after shredding and encryption as described in claim 1 further comprising:
decrypting data and computing objects;
communicating decrypted data and computing objects between single or multiple distributed cloud servers.

5. The method shredding data and computing objects before or after encryption;
as described in claim 1 further comprising:
setting required re-assembly order for shredded data and computing objects.

6. The method de-shredding data and computing objects before or after encryption;
as described in claim 1 further comprising:
tracking and verifying re-assembly order;
alerting if actual re-assembly order does not match the required re-assembly order.

7. A system for cloud storage and retrieval of data and computing objects, said data and computing objects comprising data or computing objects or both, said system comprising:
processor;
computer memory;
system to access data storage systems;
system to access cloud servers, said cloud comprising of public cloud or private cloud or both;
said cloud servers comprising storage servers or processing servers or databases or any combination thereof;
shredding system for data and computing objects, plain or encrypted;
encrypting system for data and computing objects, plain or shredded;
cloud distribution system for shredded, encrypted data and computing objects;
cloud retrieval system for shredded, encrypted data and computing objects de-shredding system for data and computing objects, plain or encrypted;
decrypting system for data and computing objects, plain or shredded;
tracking system for distributed data and computing objects, cloud servers and algorithms used in system;

8. The tracking system for distributed data and computing objects, cloud servers and algorithms used in system as described in claim 7 comprising:
cloud server verification system;
tracking systems for cloud server reliability;
shredding keys and algorithms database;
encrypting keys and algorithms database;
tracking system for cloud server performance;
tracking system for abnormal access of data and computing objects;
alerting system flagging abnormal access of data and computing objects;

9. The system as described in claim 8 further comprising:
cloud server reliability improving system via scaling or duplication or both;
cloud server performance improving system via scaling or load balancing or both;
security modification system to modify shredding and encryption algorithms;

10. The cloud distribution system for shredded, encrypted data and computing objects as described in claim 7 further comprising:
decrypting system for data and computing objects;
communication access system for communicating decrypted data and computing objects between single or multiple distributed cloud servers.

11. The shredding system for data and computing objects, plain or encrypted as described in claim 7 further comprising:
system to set required re-assembly order for shredded data and computing objects.

12. The de-shredding system for data and computing objects, plain or encrypted as described in claim 7 further comprising:
system to track and verify re-assembly order;
system to alert if actual re-assembly order does not match the required re-assembly order.
